(19) United States
(12) Patent Application Publication
(10) Pub. No.: US 2005/0207458 A1
(43) Pub. Date: Sep. 22, 2005

(54) Optoelectronic module with integrated cooler

(76) Inventor: Tieyu Zheng, Chandler, AZ (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/805,824

(22) Filed: Mar. 22, 2004

(51) Int. Cl. H01S 3/04

(52) U.S. Cl. 372/34

(57) ABSTRACT

An optoelectronic module with integrated cooler is described herein.

### FIELD OF THE INVENTION

The present invention relates generally to the field of optoelectronics.

### BACKGROUND OF THE INVENTION

Laser light has been employed to facilitate communication.

Typically, for intermediate or long range communication, the laser light source has to be cooled to ensure proper functioning of the optoelectronics, that is, the optical and electronic components within the optoelectronic modules. Currently, what is known as the “butterfly can” is probably the most popular form factor employed for this kind of laser transmitter modules, i.e. those requiring the laser light sources and/or their companion electronics to be cooled. In general, “butterfly can” has a relatively large footprint, and is relatively expensive to make.

Recently, a number of smaller footprint transceivers, such as XFP or SFP, have emerged. Traditional packaging, such as butterfly can, is unable to meet the smaller footprint and lower cost requirement. [XFP=10-Gigabit Small Form Factor Pluggable, and SFP=Small Form Factor Pluggable].

Transistor-Online (TO) packaging has been developed for 2.5 Gbit/sec or lower speed communication. It fits the smaller transceiver's footprint, and has lower cost. Applying TO packaging to higher speed applications, such as 10 Gbit/sec, would meet the new market needs. However, traditional TO cans have no provision for cooling elements, which are often required for high speed applications of 10 Gbit/sec and beyond for intermediate or long range communication.

In other words, butterfly cans are designed to accommodate cooling elements, but their footprints are too big, and too costly to manufacture, whereas TO packaging has a smaller footprint, and lower cost to manufacture, but it has no provision for cooling elements for high speed and long range applications requiring such cooling.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an exploded view of an optoelectronic module, in accordance with one embodiment of the present invention;

FIG. 2 illustrates a side view of the optoelectronic module of FIG. 1;

FIGS. 3a-3b illustrate a perspective view and a bottom view of the thermo electric cooler of FIG. 1-2, in accordance with one embodiment; and

FIG. 4 illustrates an example system having the optoelectronic module of FIG. 1-2, in accordance with one embodiment.

### DETAILED DESCRIPTION OF ILLUSTRATIVE EMBODIMENTS

Illustrative embodiments of the present invention include, but are not limited to, an optoelectronic module, a communication interface and/or system having such optoelectronic module.

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

The phrase “in one embodiment” is used repeatedly. The phrase generally does not refer to the same embodiment; however, it may. The terms “comprising”, “having” and “including” are synonymous, unless the context dictates otherwise.

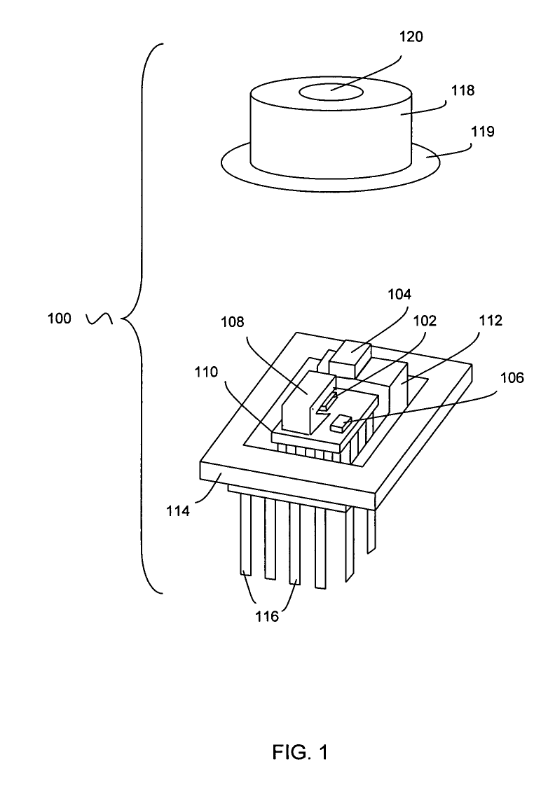

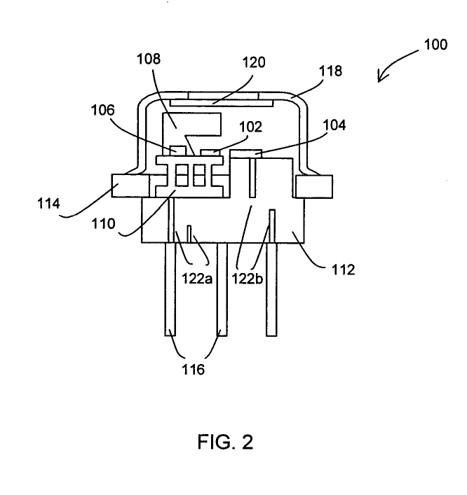

Referring now to FIGS. 1-2, wherein an exploded view and a side view of an optoelectronic module, in accordance with one embodiment, is shown. As illustrated, for the embodiment, optoelectronic module 100 includes a laser light source 102 to provide laser light for encoding data thereon for communication purpose, and a thermo electric cooler (TEC) 110 thermally coupled to laser light source 102 to cool at least the laser light source 102 during operation. More specifically, for the embodiment, laser light source 102 is disposed at the “top” surface of TEC 110. In alternate embodiments, laser light source 102 may be mounted on a submount that is on the top of TEC 110 instead.

Note that the reference to the surface of TEC 110 on which laser light source 102 is disposed as a “top” surface is made merely for ease of description and understanding. The surface could have been referred to e.g. as a “bottom” or a “side” surface. Whether, it should be referenced as a “top”, a “bottom” or a “side” surface is a matter of perspective, depending on how optoelectronic module 100 is viewed. Accordingly, the reference convention is not to be read as restrictive of the invention. Further, this note applies to all subsequent references to other surfaces of other elements as “top”, “bottom” or “side” surfaces. That is, all such references are for ease of description and understanding. The surfaces could have been referenced in other manners depending on how the elements are viewed respectively, and the references are not to be read as restrictive on the invention.

In various embodiments, laser light source 102 may be a vertical cavity surface-emitting laser device, a Fabry-Perot laser device, a distributed feedback laser device, a laser diode device, and other laser devices of the like. Further, laser light source 102 is driven for a high speed communication application, e.g. 10 Gbit/sec or higher, requiring cooling during operation.

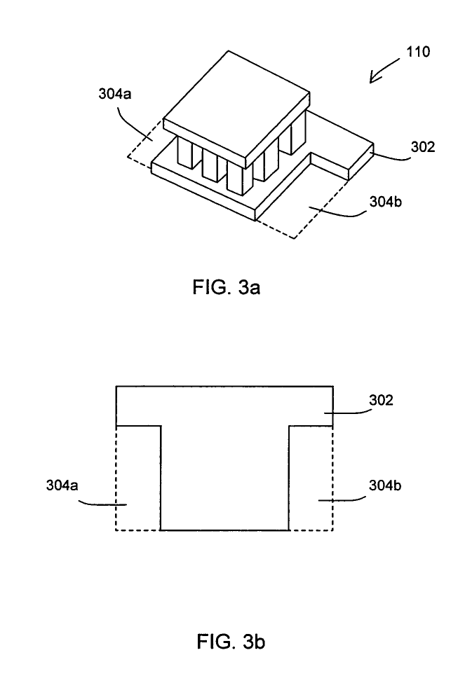

In various embodiments, TEC 110 is thermally rated to meet at least the thermal dissipation requirement of laser light source 102. Referring now briefly to FIGS. 3a-3b where a perspective view and a bottom view of TEC 110 in accordance with one embodiment is illustrated, respectively. As shown, for the embodiment, TEC 110 is further advantageously provided with a T-shape bottom 302, allowing cavities 304a-304b to be “defined”. For these embodiments, cavities 304a-304b are employed to facilitate routing of electrical traces to TEC 110, which contribute to the compactness or relative small footprint of optoelectronic module 100.

Referring back to FIGS. 1-2, optoelectronic module 100 is further advantageously formed with a stepped substrate 112, having a number of vias 122a-122b. Input and/or output pins 116 are attached to the “bottom” surface of substrate 112. Vias 122a are employed to facilitate routing of electrical connections from selected one(s) of I/O pins 116 to TEC 110. Usage of vias 122b will be further described below. In various embodiments, the lower portion of stepped substrate 112 is about 1 mm in “height”, and the higher portion is about 1.5 mm in “height”. In alternate embodiments, substrate 112 and the different portions may have heights of other values. Similar to the earlier note with respect to referencing a surface as a “top”, “bottom” or “side” surface, the enumerated dimensions could have been described as “length” or :width”, depending on how optoelectronic module 100 is viewed. Accordingly, these dimension references are also not to be read as restrictive on the invention.

As illustrated, for the embodiment, TEC 110 is disposed in the lower portion of substrate 112, and the “step” or higher portion of substrate 112 has a height that is substantially the same as TEC 110, to allow laser light source 102 to be substantially co-planar with the “top” surface of the step or higher portion of substrate 112. As illustrated, this feature allows e.g. a driver or an amplifier 104 to be optionally placed in very close proximity of laser light source 102. For these embodiments, vias 122b are employed to facilitate routing of electrical connections from selected one(s) of I/O pins 116 to optional driver/amplifier 104. The co-planar and proximal attributes enable relatively short leads to be employed to electrically couple laser light source 102 to optional driver or amplifier 104 (if it is disposed as shown). The arrangement potentially contributes to improving the performance of optoelectronic modules 100.

In various embodiments, substrate 112 is made of a ceramic material with a suitable thermal conductivity. Similarly, ceramic may be used to form the substrate of RF circuity. More specifically, in various embodiments, the ceramic material is a selected one of aluminum nitride, beryllium oxide, alumina, and other ceramic materials with suitable thermal conductivity and similar dielectric constants.

Still referring to FIGS. 1-2, for the embodiment, optoelectronic module 100 further includes mirror assembly 108 which is employed to assist in re-directing the light bundles emitted by laser light source 102 from a direction that is substantially parallel with the “top” surface of TEC 110 to a direction that is substantially orthogonal to the “top” surface of TEC 110. Any one of a number of mirrors (conventional, micro or otherwise) may be employed to implement mirror assembly 108. In alternate embodiments, prisms, and/or other optical devices with like properties may also be employed in conjunction or instead.

Further, in various embodiments, one or more other electronic elements, represented by element 106, may also be disposed on the “top” surface of TEC 110.

Continuing to FIGS. 1-2, optoelectronic module 100 further includes overhanged ring 114, which is disposed on the perimeter of substrate 112 as shown. Overhanged ring 114 is provided to assist in the engagement of cap 118 to seal laser light source 102 and the various electronic elements, such as elements 104-106, including optical elements, such as mirror assembly 108.

More specifically, overhanged ring 114 is designed to mate with flanges 119 of cap 118. Cap 118 may be mated with overhanged ring 114 in a variety of manners, including but are not limited to welding, in particular, projection welding. In various embodiments, overhanged ring 114 is about 0.5 mm in thickness.

For the embodiment, overhanged ring 114 is substantially square in shape, however, in alternate embodiments, overhanged ring 114 may assume other geometric shapes, including but are not limited to other polygon, circular or oval shapes.

For the embodiment, in addition to flanges 119, cap 118 includes optical window 120. More specifically, optical window 120 is complementarily disposed at the center portion of cap 118 to facilitate exit of the orthogonally re-directed laser light bundles emitted by laser light source 102. In various embodiments, optical window may be a flat glass window, a ball lens, an aspherical lens, a GRIN lens, or other lens of the like.

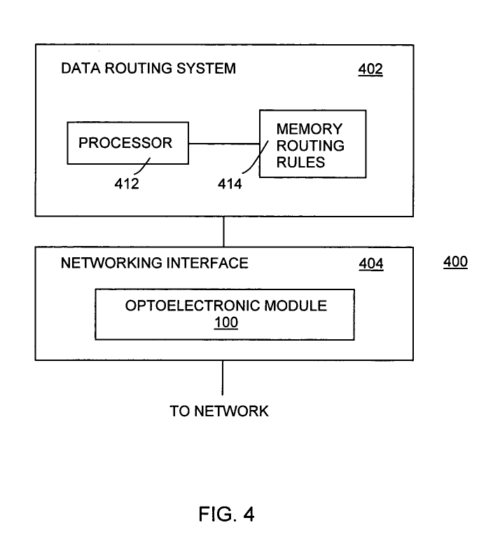

FIG. 4 illustrates an example communication system, in accordance with one embodiment. As illustrated, example system 400 includes data routing subsystem 402 and networking interface 404 coupled to each other as shown. Networking interface 404 is employed to optically couple communication system 400 to a network, which may be a local area network, a wide area network, a telephone network, and so forth. These networks may be private and/or public. For the embodiment, networking interface 404 includes in particular, optoelectronic module 100 of FIG. 1, to facilitate optical communication. For the purpose this specification and the claims, networking interface 404 may also be referred to as a communication interface.

Still referring to FIG. 4, for the embodiment, data routing subsystem 402 includes processor 412 and memory 414 coupled to each other as shown. Memory 414 has stored therein a number of data routing rules, according to which processor 412 routes data received through networking interface 404. The data routing rules may be stored employing any one of a number data structure techniques, including but are not limited to tables, link lists, and so forth. Data may be received and routed in accordance with any one of a number of communication protocols, including but are not limited to the Transmission Control Protocol/Internet Protocol (TCP/IP).

Except for the incorporation of optoelectronic module 100 with networking interface 402, elements 402-404 represent a broad range of these elements known in the art or to be designed.

In various embodiments, example system 400 may be a router, a switch, a gateway, a server, and so forth.

As those skilled in the art would appreciate, the foregoing embodiments provide an optoelectronic package having a relatively small footprint, and yet able to accommodate cooling elements for a high speed e.g. 10 Gbit/sec application. In various embodiments, the length and width of the module may be about 5.4 mm, and the height of the module may be about 5˜10 mm, providing a substantially smaller foot print than the butterfly can, whose length is over 19 mm, width over 7 mm, and height over 7 mm. A laser in such package may nonetheless dissipate e.g. 0.1 W heat, with a heat of e.g. 0.2˜0.4 W going into the module from the ambient, yet the TEC of this footprint can dissipate the total heat (as much as 0.5 W) to maintain the temperature of the laser device at about 25˜35° C., while the module case in the communication system is about 70° C.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

1. An optoelectronic apparatus comprising:
a substrate having a stepped surface;
a thermal electric cooler disposed on a lower portion of the stepped surface of the substrate; and
a laser light source disposed on the thermal electric cooler.

2. The optoelectronic apparatus of claim 1, wherein the substrate comprises a ceramic material.

3. The optoelectronic apparatus of claim 1, wherein the ceramic material comprises a selected one of aluminum nitride, alumina, and beryllium oxide.

4. The optoelectronic apparatus of claim 1, wherein the substrate comprises a plurality of vias to facilitate routing of electrical connections to the thermal electric cooler.

5. The optoelectronic apparatus of claim 1, wherein the thermal electric cooler comprises a T-shaped bottom portion.

6. The optoelectronic apparatus of claim 1, wherein the apparatus further comprises a selected one of a driver and an amplifier disposed on an upper portion of the stepped surface of the substrate, and coupled to the laser light source.

7. The optoelectronic apparatus of claim 6, wherein the substrate comprises a plurality of vias to facilitate routing of electrical connections to the selected one of the driver and the amplifier.

8. The optoelectronic apparatus of claim 1, wherein the laser light source comprises a selected one of a vertical cavity surface-emitting laser device, a Fabry-Perot laser device, a distributed feedback laser device, and a laser diode device.

9. The optoelectronic apparatus of claim 1, wherein the apparatus further comprises a laser light steering mirror subassembly disposed on the thermal electric cooler, adjacent to the laser light source.

10. The optoelectronic apparatus of claim 1, wherein the apparatus further comprises an overhanged welding ring disposed around the substrate.

11. The optoelectronic apparatus of claim 1, wherein the apparatus further comprises a cap with an optical window to cover the laser light source and the thermal electric cooler.

12. The optoelectronic apparatus of claim 11, wherein the optical window comprises a selected one of a flat glass window, a ball lens, an aspherical lens or a GRIN lens.

13. A method comprising:
emitting laser light from an enclosed environment employing a laser light source device disposed within the enclosed environment;
cooling the laser light source employing a thermal electric cooler disposed within the enclosed environment, and
dissipating thermal energy from the thermal electric cooler through a substrate that is at least partially disposed within the enclosed environment, and dissipating thermoelectricity from the thermal electric cooler through electrical connections disposed in first plurality of vias of the substrate.

14. The method of claim 13, wherein
the substrate comprises a stepped surface having a lower portion and a higher portion; and
the thermal electric cooler is disposed on the lower portion of the stepped surface, resulting in said dissipating of the thermal energy and thermoelectricity being effectuated through the lower portion of the stepped surface.

15. The method of claim 14, wherein the method further comprises providing electrical signals to a selected one of the laser light source, a driver coupled to the laser light source, and an amplifier coupled to the laser light source, through a second plurality of vias of said substrate and said higher portion of the substrate.

16. A system comprising:
a data routing subsystem including memory having a plurality of data routing rules, and a processor coupled to the memory to route data based at least in part on the data routing rules; and
a networking interface coupled to the data routing subsystem to optically receive and forward data for the data routing subsystem, the networking interface having an optoelectronic module including
a substrate having a stepped surface;
a thermal electric cooler disposed on a lower portion of the stepped surface of the substrate; and
a laser light source disposed on the thermal electric cooler.

17. The system of claim 16, wherein the substrate of the optoelectronic module comprises a plurality of vias to facilitate routing of electrical connections to the thermal electric cooler.

18. The system of claim 16, wherein the thermal electric cooler of the optoelectronic module comprises a T-shaped bottom portion.

19. The system of claim 16, wherein the optoelectronic module further comprises a selected one of a driver and an amplifier disposed on an upper portion of the stepped surface of the substrate, and coupled to the laser light source.

20. The system of claim 19, wherein the substrate of the optoelectronic module comprises a plurality of vias to facilitate routing of electrical connections to the selected one of the driver and the amplifier.

21. The system of claim 16, wherein the optoelectronic module further comprises an overhanged welding ring disposed around the substrate.

22. The system of claim 16, wherein the optoelectronic module further comprises a cap with an optical window to cover the laser light source and the thermal electric cooler.
